(19) United States
(12) Patent Application Publication
(10) Pub. No.: US 2006/0287831 A1
(43) Pub. Date: Dec. 21, 2006

(54) Method for visualizing data on correlation between biological events, analysis method, and database

(76) Inventors: Motoi Totiba, Tokyo (JP); Tetsuo Nishikawa, Chiba (JP); Ken Horiuchi, Chiba (JP); Masashi Nemoto, Chiba (JP); Kenji Araki, Shizuoka (JP)

Correspondence Address: BIRCH STEWART KOLASCH & BIRCH, PO BOX 747, FALLS CHURCH, VA, 22040-0747, US

(21) Appl. No.: 10/569,494

(22) PCT Filed: Jul. 12, 2004
(86) PCT No.: PCT/JP04/10250

§ 371 Date: Feb. 27, 2006

(30) Foreign Application Priority Data
Oct. 7, 2003 (JP) 2003-348438

(51) Int. Cl. G06F 19/00

(52) U.S. Cl. 702/19

(57) ABSTRACT

One of a plurality of data display formats with different units of correlation data that are prepared in advance is automatically selected depending on the variation of the amount of data in terms of the number of items thereof. One of a plurality of display methods with different summarization levels that are prepared in advance is also automatically selected for information (about correlation data or individual events) regarding individual cells. Information about the correlation data and individual cells is then displayed. The amount of work required to repeat the operation of observing the correlation data as a whole and the detailed observation of a small amount of data is reduced in a method for visualizing correlation data concerning two events in a matrix format.

### TECHNICAL FIELD

The present invention relates to a method for visualizing correlated data concerning different biological events, particularly information about interactions between substances in living bodies, such as proteins, low-molecular-weight (“LMW”) compounds, and DNA, and expression profiles and the like of genes. The invention also relates to a graphical user interface and a visualizing system incorporating the aforementioned method. Further, the invention relates to an analysis method and a database incorporating the aforementioned method.

### BACKGROUND ART

With the completion of the Human Genome Project, information about gene sequences and, moreover, the protein sequences encoded thereby is being comprehensively accumulated. Currently, functional analyses are being actively carried out using such sequence information and proteins, with a view to creating new diagnostic methods and drugs. Knowing protein-protein interactions has a very important meaning in examining the functions of proteins, because the proteins' interactions with other substances in the living body are nothing less than the functions of the proteins. It is believed that, besides protein-protein interactions, correlation information concerning two substances, or, more generally, two events, such as the expression profiles of individual libraries of genes or protein-LMW compound interactions, will shed light on the function of substances in a living body as a system. With regard to protein-LMW compound interactions, relevant interaction data provides insight into what group of proteins is influenced by LMW compounds, or, conversely, by what LMW compound a particular protein is influenced. When information is available about the level or timing of expression of proteins, or interaction between one protein and another protein, such information and protein-LMW compound interaction information can be combined, whereby the function of proteins in the living body can be clarified, and prediction can be made regarding how the function will be changed by a LMW compound. In other words, it becomes possible to predict whether or not a drug can be made from the LMW compound. Supported by these backgrounds, collection of data concerning two different biological events has started on a large scale in recent years. In this connection, there is the problem that it becomes increasingly difficult to have an overview of data as a whole and to extract features therefrom, as the volume of data increases. There is the problem that, a large number of detailed references will be required for individual items of data, resulting in the frequent observation of individual sites, as the amount of data increases. Thus, the importance of information visualizing methods for effectively extracting information hidden in large volumes of correlation data is increasing.

In a method for visualizing a large volume of correlation data, a matrix is utilized in which one event is represented in the rows and the other event is represented in the columns, and correlation data concerning the two events is described in the cells where the rows and columns intersect with one another. With regard to expression profiles, a method is generally employed whereby different colors corresponding to expression intensities are displayed in the cells of a matrix. For the visualization of protein-protein interactions, too, a method is employed whereby different colors or shades corresponding to interactions are displayed in the cells of a matrix. For the visualization of protein-LMW compound interactions, too, a method is employed whereby qualitative information, such as “++” or “+,” corresponding to interactions is displayed in the cells of a matrix (PCT: WO 02/23199 A2).

In the method for displaying the correlation information concerning two events using a matrix, clustering is generally performed on the basis of patterns in the correlation data of the matrix. By analyzing the nature of the events in the obtained clusters, correspondence between correlation information and the features of each event can be known. Similarly, by sorting the events according to the features of individual events and comparing the resultant correlation information pattern with the features of the events, correspondence between the correlation information and the features of each event can be known. As inferred, in the method of visualizing correlation data using a matrix, it is important that both correlation information patterns and the features of each event can be observed.

Therefore, in an effective method for viewing information, correlation data of a large size in terms of the number of data items thereof is displayed in a matrix, and then characteristic patterns are identified by clustering according to the correlation data patterns or by sorting according to the features of each event. Thereafter, feature quantities regarding the constituent elements of the identified patterns or detailed information about interaction information are accessed, so that it becomes possible to consider the meaning of the obtained patterns. Further, by performing the clustering or sorting in a different manner from the aforementioned clustering or sorting, observing the entirety of the resultant correlation data pattern, and then examining the results to see to what cluster the individual interactions and events that have previously been considered belong, a new discovery could be made. As inferred, by repeating the process of going back and forth between the matrix display of a large quantity of correlation data and the display of individual correlation data, it is believed that new knowledge about correlation data can be discovered.

However, in the conventional method for visualizing correlation data using a matrix, there has been the problem that appropriate information commensurate with the amount of data could not be obtained if the number of data items varies greatly. For example, assume that the number of pixels on a screen is approximately 1000 pixels×1000 pixels in height and width (30 cm×30 cm in dimensions). If the data amount is on the order of dozens to 100 items, the number of pixels per cell would be from 10 to dozens of pixels×from 10 to dozens of pixels, which is approximately several mm² to 1 cm² in dimensions. On this order, the patterns of colors or shades and the individual data points are simultaneously observable.

However, if the data amount increases to the order of several hundreds of items or more, the number of pixels per cell becomes several pixels×several pixels, such that the size of each cell would be 1 mm² or smaller. In this case, the cells would be so small that the pattern information becomes complex and, at the same time, it becomes difficult to recognize the individual cells. There would also arise the problem of increased rendering time. Thus, when the data amount reaches the order of several hundreds of items or more as mentioned above, coarse-visualization of patterns can be selected for the description of a single piece of correlation data whereby a certain number of cells or a plurality of cells corresponding to a cluster are considered together. In this way, the size of each cell can be made to be on the order of several mm to 1 cm×several mm to 1 cm, so that the correlation data pattern and the individual data points can be simultaneously observed. Conventionally, it was previously necessary to conduct this operation manually by the user in a painstaking process.

Conversely, if the size of the rows or columns decreases to dozens or less, the amount of information that can be obtained from the entire screen decreases even though the number of pixels per cell is dozens of pixels×dozens of pixels or more, which corresponds to a fairly large size for each cell; that is, several cm². This is due to the fact that the information amount per cell remains at only a level such that it can be represented by colors. If, in order to increase the amount of information obtainable from the entire screen, information about individual cells is to be referred to, it is necessary to access a different information source for each cell. In this case, it has been difficult and troublesome to simultaneously refer to the correlation data pattern and the information about the multiple cells that comprise the pattern.

### DISCLOSURE OF THE INVENTION

It is an object of the invention to provide means for simultaneously observing a correlation data pattern and information about the multiple cells of which the pattern is comprised in an appropriate manner depending on the variation in the data number size, in a visualizing method for displaying correlation data concerning two events in a matrix.

As discussed in the Background Art section, in a visualizing method for displaying correlation data concerning two events using a matrix, in order to simultaneously observe a correlation data pattern and information about multiple cells of which the pattern is comprised, it has been necessary to perform some operations, such as coarsely visualizing the correlation data pattern (in which multiple cells are considered together and summarized by clustering and the like), or accessing other sources of information for each cell, depending on the size of the correlation data. In addition, in conventional methods, such operations had to be done manually. As stated with reference to conventional art, in order to discover effective knowledge from a large volume of correlation data, the process of observing the correlation data as a whole and observing a smaller number of items of data in detail has to be repeated. In conventional manual methods, this repetition operation has been done only very inefficiently. As a result, the efficiency with which useful knowledge for the creation of drugs could be extracted from a large volume of data has been low.

In order to solve the aforementioned problem, in a screen display system for displaying correlation data concerning two events in a matrix format according to the invention, one of a plurality of data display formats having different levels of integration of data per unit correlation data that are prepared in advance is automatically selected depending on the variation of the amount of data in terms of the number of items thereof. Also, one of a plurality of display methods having different summarization levels that are prepared in advance for information (about correlation or individual events) regarding individual cells is automatically selected. Then, correlation data and information about individual cells are displayed.

In a typical example of correlation data concerning two events, one event is a protein and the other event is a LMW compound, and the correlation data concerning the events is the intensity of interaction between the protein and the LMW compound. Alternatively, both events may involve proteins and the correlation data concerning the events may be the intensity of protein-protein interaction, or sequence similarity between the proteins. Further alternatively, one event may be gene and the other may be a cDNA library from which the gene derives, and the correlation data concerning the events may be the expression intensity of the gene for each cDNA library. Yet further alternatively, both events may be LMW compounds and the correlation data concerning the events may be structural similarity between the LMW compounds or interaction between them in terms of drug efficacy or side effects.

An analysis for obtaining useful knowledge from a large amount of correlation data, such as protein-LMW compound interaction data, is performed in two steps. A first step involves the rearrangement of data. There are a plurality of methods for rearrangement. The data can be rearranged either in order of decreasing or increasing one of physical properties of proteins. It is also possible to rearrange according to a classification of proteins. Similarly, data can be rearranged in order of decreasing or increasing one of the physical properties of compounds. The data can be also rearranged according to a classification of LMWs. Furthermore, it is also possible to rearrange proteins or LMW compounds on the basis of similarity in terms of protein-LMW compound interaction intensitie such that proteins or LMW compounds with similar interaction are arranged next to each other. The calculation of similarity between proteins and between LMW compounds based on the intensity of interaction is referred to as clustering, which is a useful data classifying or rearranging technique for extracting knowledge from interaction information between two events in particular. As a result of clustering, a table that shows interaction intensities is displayed such that portions with greater strengths and portions with less strength are displayed separately. By displaying the portions with greater intensities with a darker shade, these portions can be made to appear like islands on the sea. Each of these “islands” is referred to as a cluster. Because the clusters with greater intensities will get more attention, detailed observation of the clustering results can be made sequentially from the more important clusters by arranging the individual clusters on a diagonal in order of decreasing intensity.

In a second step, the clusters obtained as a result of clustering are analyzed one by one in detail. Initially, the clusters are classified into three groups, namely, long clusters, large clusters, and singletons. The long clusters are those that are formed when a plurality of proteins strongly interact with respect to a single LMW compound, or when a plurality of LMW compounds strongly interact with respect to a single protein. The large clusters are those that are formed when all or some of combinations of a plurality of LMW compounds and a plurality of proteins strongly bind to one another. Finally, the singletons are those that are formed when a specifically strong interaction is seen in combinations of a single LMW compound and a single protein.

Those three kinds of clusters are analyzed differently. In the analysis of the long clusters, a common portion of the plurality of LMW compounds (or proteins) is extracted. The common portion may be the possible range of numerically expressed physical property, or a structurally similar feature. The attributes of the compounds or proteins may be expressed by a profile consisting of a plurality of elements. Such a common portion is believed to be an indispensable factor for producing the bond with a target protein (or target LMW compound). In particular, a structural feature portion of a LMW compound that is involved in the binding with a target protein is related to a concept referred to as pharmacophore. Pharmacophore refers to information that has an important role in drug discovery. Conversely, the structural feature portion of a protein that is involved in the binding with a target LMW compound refers to an active site of the protein that is denoted by terms such as “binding pocket” or “cavity.” By closely observing the shape of such active sites, it becomes possible to design a molecule such that it maintains an interaction with a certain protein in a cluster but it loses interaction with another protein in the cluster based on the structural modification of the LMW compound. Once the common partial structure has been extracted, the LMW compounds (or proteins) that do not belong to the cluster are searched for LMW compounds (or proteins) that have a similar common partial structure. The LMW compounds (or proteins) that are obtained as a result of the search are those in which no strong interaction with the target protein (or LMW compound) has been recognized by the definition of the cluster. Therefore, it is also important to extract such physical properties or structural features that make it possible to clearly distinguish the LMW compounds (or proteins) that belong to the cluster from the LMW compounds (or proteins) that do not belong to the cluster but that have a similar common structure. When there is a long cluster, the intensity of interaction in each element in the cluster is thought to be different. However, when the elements are rearranged in the cluster in order of interaction intensity, the extraction of a physical property or structural feature that can explain the change in interaction intensity can provide useful knowledge that can lead to, in the case of a LMW compound, the designing of a LMW compound that more specifically binds to the target protein, by optimizing the physical property or structural feature.

In the analysis of a large cluster, basically the analysis for the long cluster is repeated several times in the direction of proteins and in the direction of LMW compounds. In the analysis of a large cluster, several times more knowledge than obtained in the analysis of the long cluster can be obtained, so that, by combining them, features in terms of physical property or structural feature of the LMW compound or protein can be clarified in a more reliable manner.

Possible examples of the profile consisting of a plurality of elements for expressing the attributes of a compound or protein include an interaction profile with respect to proteins, an expression profile of proteins, and a profile of drug efficacy or side effects of LMW compounds. By using these profiles, it becomes possible to classify the proteins or LMW compounds in a cluster obtained on the basis of protein-LMW compound interaction, according to similarity when seen through these profiles.

Finally, in the analysis of a singleton, the concept of extracting a common partial structure as used in the analysis of a long cluster or a large cluster cannot be used. However, because the LMW compound and protein, which are constituent elements of a singleton, are a pair that specifically bind to each other, it is most important to consider the biological importance of this pair. The pair might be in a relationship between a drug and its target protein. It might be in a relationship between a LMW compound that causes a side effect and its target protein. Or it might not cause any biologically meaningful change if they bind to each other. If the pair is in a relationship between a drug and its target protein, it could be possible to design a LMW compound that more specifically binds to a target protein on the basis of chemical modification.

Finally, the cluster analysis results in the second step are stored in a database. Specifically, a database is created by collecting the result of analysis of the common attributes of the interaction clusters, and related known information (about protein-protein interactions, complexes of LMW compounds and proteins, toxicity information about LMW compounds, and expression information about proteins, for example) extracted from documents or patents. The database is provided with search functions for the known related information based on the cluster analysis results or for the cluster analysis results based on the known information. By utilizing these search functions, the user is enabled to render biological or pharmaceutical interpretations on an interaction cluster.

While the analysis in the above-described two steps aims to extract useful knowledge for drug discovery from a large amount of data, there is a problem that the amount of data in the first step is so much that it is difficult to display the entire data in the form of a table and to figure out the meaning of the data therefrom. On the other hand, in the second step, because the data is observed in detail on a cluster by cluster basis, more detailed data must be viewable on the screen. In an actual analysis, data analysis proceeds as these steps are repeated. Thus, there is a need for a system wherein the process of displaying a large amount of data in a concise manner and observing a relatively small amount of data in greater detail can be repeated easily.

In accordance with a screen display method of the invention, the data display formats include: (A) a display format (referred to as “individual data display format”) in which the elements of correlation data themselves, such as the coupling constants of LMW compounds and proteins, are used as screen display data units; (B) a display format in which groups of a plurality of items of interaction data are used as screen display data units (each group of a plurality of items of interaction data being a cluster obtained by clustering based on correlation data patterns or features of events; hence the format is referred to as a cluster display format); and (C) a display format (statistical display format) in which statistical values of a plurality of items of correlation data are used as screen display data units. The statistical values of correlation data refer to the number of clusters itself or the number of items of related information obtained from a separate data source regarding each element of the cluster, for example.

In accordance with a screen display method of the invention, information about individual cells (information regarding correlation or individual events) is displayed in accordance with a plurality of summarization levels that are set depending on the amount of information. The summarization levels are defined such that they have greater values as the amount of information for expressing a single event decreases.

The plurality of summarization levels defined in accordance with the invention are as follows. When all of the information items that are stored in a data field and that do not overlap one another in meaning are displayed on screen, the data summarization level is defined to be 0 because the data is not summarized. Data formats are defined in advance that correspond to a plurality of summarization levels for different kinds of data fields. For example, in the display of real number data that includes an exponential portion, the following levels can be adopted:

Summarization level 0: display the field values themselves.

Summarization level 1: display only the exponential portion.

Summarization level 2: classify the values in the exponential portion into five clusters and then display the information using colors associated with the clusters.

Summarization level 3: Display only those that are above a certain threshold value with a color.

In the display of character string data that represents a layered structure, the following levels can be adopted:

Summarization level 0: display the definition of each layer of the layered structure in a staircase-like manner.

Summarization level 1: display the definition of only the upper-most or lower-most layer of the layered structure.

Summarization level 2: display information corresponding to the upper-most or lower-most layer using symbols or colors in a projected manner.

Summarization level 3: display the values of the upper-most layer of the layered structure with associated colors.

A screen display method according to the invention comprises the step of selecting one of the aforementioned multiple data display formats, either automatically or manually, in accordance with the variation of the amount of data in terms of the number of items thereof, the step of selecting one of the aforementioned multiple display methods having different summarization levels for the information (about correlation or individual events) regarding individual cells, either automatically or manually, and the step of displaying the correlation data and information about individual events using the selected data display format and the summarization level.

When the data display format and the summarization level according to the invention are automatically selected, the selection is made such that the amount of information displayed on screen is maintained in the vicinity of a certain value near the maximum amount of information that can be recognized by the user. In other words, the data display format and the summarization level are automatically selected such that all of related information can be displayed within a single screen. However, some scrolling of the screen may be permitted.

In this way, it becomes possible to observe the information about a correlation data pattern and a plurality of cells of which the pattern consists in an appropriate format that is automatically selected depending on the variation in the amount of data in terms of the number of items thereof, without having to manually implement operations such as the coarse visualization of the correlation data pattern or accessing other sources of information for individual cells depending on the size of correlation data in a visualizing method for displaying correlation data concerning two events in a matrix format. As a result, it becomes possible to implement the operation of repeating the observation of correlation data as a whole and the observation of a relatively small amount of data in detail far more efficiently than possible with the conventional manual operation. Thus, it becomes possible to discover useful knowledge from a large amount of correlation data efficiently.

### BRIEF DESCRIPTION OF THE DRAWINGS

FIG. 1 shows a flowchart of data visualization.

FIG. 2 shows an example of the screen display of interaction data regarding LMW compounds and proteins.

FIG. 3 shows an example of the screen display of data sorted according to the result of clustering based on an interaction data profile.

FIG. 4 shows an example of the screen display of data sorted according to the result of clustering based on feature quantities in the rows and columns.

FIG. 5 shows an example of the display of information in a cluster display format.

FIG. 6 shows an example of the screen display of information in an individual data display format at four summarization levels.

FIG. 7 shows rules for the determination of the data display format and the data summarization level.

FIG. 8 shows a summarization rule determination table for a LMW compound physical property table.

FIG. 9 shows the outline of a method for extracting related information.

FIG. 10 shows the result of extraction of related information.

FIG. 11 shows an example of the screen of a user interface implementing the invention.

FIG. 12 shows results before and after clustering of PLD data into 25 groups of LMW compounds and 15 groups of proteins.

FIG. 13 shows an example of two kinds of display of the clustering results of the PLD data.

FIG. 14 shows a LMW compound-protein interaction matrix, beside which there are also shown an expression profile matrix of cell tissues of proteins and an adverse event matrix of LMW compounds.

FIG. 15 shows an example in which LMW compound-protein interaction information obtained experimentally and known LMW compound-protein interaction information obtained from documents and the like are shown simultaneously in a single matrix.

FIG. 16 shows a matrix in which chemical structural similarity information about pharmaceutical LMW compounds and classification information based on an adverse event matrix are simultaneously shown in a single matrix as interactions between two events.

FIG. 17 shows an example of display of information about complexes of proteins and LMW compounds using a two-dimensional table.

In the following, the numerals used in the drawings are explained.
101: user operation, 102: internal calculation, 103: data processing, 104: protein-LMW compound interaction database, 105: tables of various correlations, 106: display data, 107: data display format and summarization level determination rules
201: LMW compound labels, 202: protein labels, 203: matrix portion, 204: molecular weight, 205: number of alpha helixes and beta strands, 206: clustering information based on homology
301: LMW compound cluster A, 302: LMW compound cluster B, 303: LMW compound cluster C, 304: protein cluster A, 305: protein cluster B, 306: protein cluster C, 307: cluster consisting of pairs of particular LMW compounds and proteins, 308: cluster consisting of pairs of compounds and a single protein that have a specific interaction
401: cluster A with a relatively large molecular weight, 402: cluster B with an intermediate molecular weight, 403: cluster C with a relatively small molecular weight, 404: cluster 1 based on the homology of amino acid sequences, 405: cluster 2 based on the homology of amino acid sequences, 406: region with a relatively strong interaction
501: labels, 502: number of elements that belong to a cluster, 503: list of elements that belong to a cluster, 504: matrix portion
601: screen display at summarization level 0, 602: screen display at summarization level 1, 603: screen display at summarization level 2, 604: screen display at summarization level 3
701: summarization level, 702: data items, 703: location, 704: summarization rules, 705: rule “As is”, 706: rule “colors (200, 300, 400, 500)”
801: condition, 802: display format, 803: summarization level
901: protein-LMW compound interaction table, 902: protein-protein interaction table
903: protein-expression table, 904: LMW compound-LMW compound interaction table
1101: display mode change button, 1102: summarization level change button, 1103: related information acquisition button, 1104: functions related to actions, 1105: functions related to selection, 1106: related information display area
1201: matrix before clustering, 1202: matrix after clustering, 1203: region where meaning can be recognized in the result of clustering, 1204: region where dissimilar interaction data is mixed in the result of clustering
1301: example in which part of matrix data having clusters as units is displayed on screen at summarization level 2, 1302: number of LMW compounds that belong to a cluster, 1303: number of proteins that belong to a cluster, 1304: number of interactions that belong to a cluster, 1305: display of matrix having individual proteins and LMW compounds as units, 1306: cluster represented by a matrix of 12 vertical elements and 1 horizontal element, 1307: physical property values of a group of compounds that are elements of a cluster, 1308: cluster in which physical properties of compounds are associated with interaction intensities, 1309: physical properties of compounds that are elements of cluster 1308, 1310: table in which the values of the interaction intensities of cluster 1308 and the values of the physical property values 1309 are projected to values in three stages
1401: matrix of LMW compound-protein interaction, 1402: expression profile matrix of cell tissues, 1403: adverse event matrix, 1404: LMW compound-protein interaction cluster, 1405: LMW compound-protein interaction cluster, 1406: LMW compound-protein interaction cluster region, 1407: LMW compound-protein interaction cluster region, 1408: LMW compound-protein interaction cluster region, 1409: LMW compound-protein interaction cluster region, 1410: expression profile in cell tissues, 1411: expression profile in cell tissues, 1412: profile of an adverse event matrix, 1413: profile of an adverse event matrix
1501: LMW compound-protein interaction matrix, 1502: cluster obtained by clustering based on known interaction information, 1503: interaction obtained experimentally that does not belong to the cluster of the known interaction information
1601: matrix in which chemical structural similarity information about pharmaceutical LMW compounds and classification information based on an adverse event matrix are simultaneously displayed, 1602: cluster obtained by clustering based on the chemical structural similarity information, 1603: pairs of LMW compounds C5 and C4, 1604: pairs of compounds that do not have chemical structural similarity
1701: matrix in which information about the distances between the centers of gravity regarding to a complexe of protein and LMW compound is displayed, 1702: cluster including LMW compounds, 1703: model of a protein-LMW compound complex

### BEST MODES FOR CARRYING OUT THE INVENTION

In the following, embodiments of the invention will be described with reference to the drawings.

### Embodiment 1

As a correlation between two events, an interaction between substances in a living body, such as proteins, LMW compounds, and DNA is considered. In the following embodiment, data about interactions between “LMW compounds” and “proteins” is handled as the two events that are considered. The term “interaction data” herein refers to information about whether or not there is data about complexes between LMW compounds and proteins in the Protein Data Bank (PDB, http://www.pdb.org), and experimentally measured data showing the degree of binding between LMW compounds and proteins. Feature data about proteins includes the information in various external databases and the calculated results of clustering. It includes, for example, the IDs in SWISSPROT (http://www.expacy.ch/sprot), the clustering results based on amino acid sequence homology, the annotation information based on Gene Ontology (http://www.geneontology.org), and solubilities in a solvent. Feature data about LMW compounds include the names of molecules, molecular weights, therapeutic category, and other various molecular characteristic values, such as charge distribution, hydrophilic or hydrophobic property, three-dimensional structure, the number of donors or acceptors for hydrogen bond, and the kind and number of functional groups.

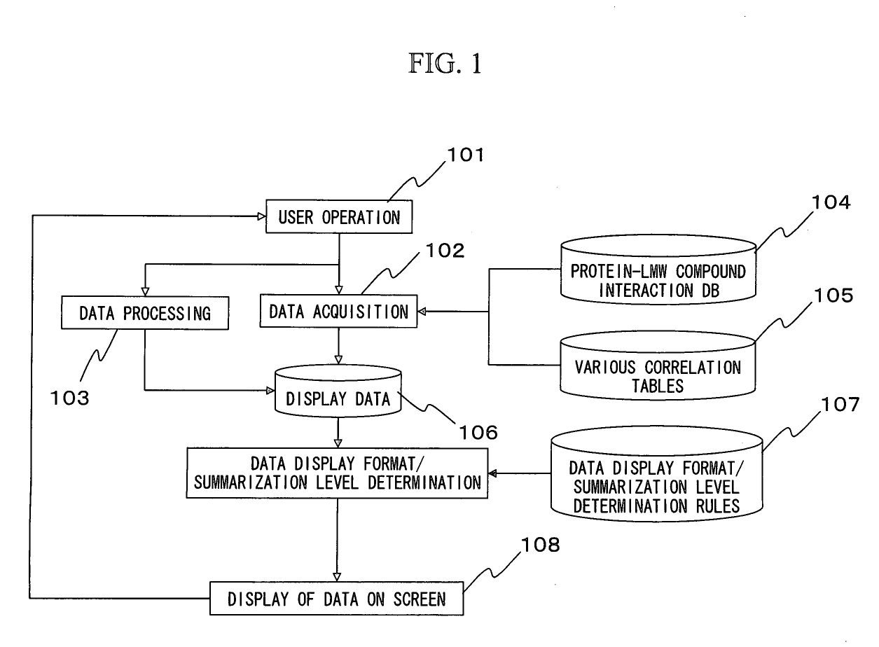

With reference to FIG. 1, a flowchart of data visualization is described. A user operation 101 is where data and an action to be performed are selected. Actions include data acquisition 102 and data processing 103. Data acquisition may involve data acquisition by searching a protein-LMW compound interaction database 104 using various search conditions, or data acquisition related to a protein or a LMW compound designated on the display screen from a various-correlation table 105. Data processing may involve clustering entries designated on the display screen, or changing the display scale, for example. The acquired or processed data is handled as display data 106. Then, with regard to the display data, a data display format and a summarization level are determined. The data display format and the summarization level are determined in accordance with a data display format/summarization level determination rule 107 that is prepared in advance, depending on the number of data items in the display data. In accordance with the data display format and the summarization level that have been determined, data screen display 108 is carried out. Conceivable examples of the various correlation table include a protein-protein interaction table, a protein expression profile table, a LMW compound-LMW compound structural similarity table, and a therapeutic or toxicological interaction table.

The main point of the invention, namely, “the data display format and the summarization level are determined in accordance with a data display format/summarization level determination rule that is prepared in advance, depending on the number of data items in the display data,” is described in detail below.

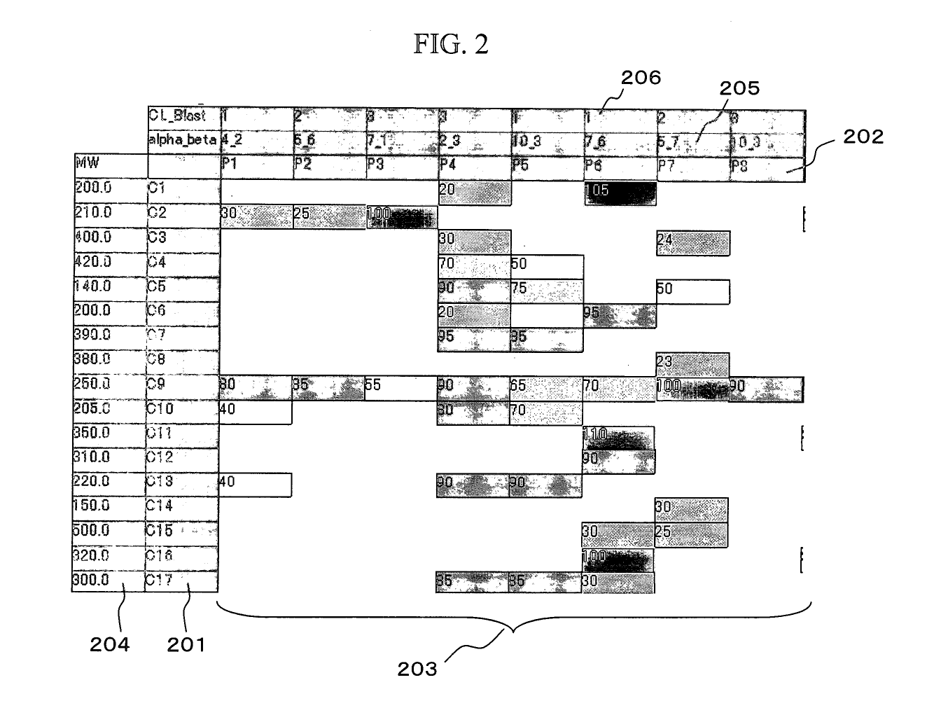

First, the data display format is described. FIG. 2 shows an example of a screen display of interaction data concerning LMW compounds and proteins. Labels 201 for LMW compounds are arranged in the vertical direction of the matrix, and labels 202 for the proteins are arranged in the horizontal direction. In a matrix portion 203, there are displayed those experimentally measured coupling constants between proteins and LMW compounds that exceed a certain threshold value, with the bond intensities indicated by different shades. To the left of the compound labels, there are displayed molecular weights 204 as a feature quantity of the compounds. On top of the protein labels, there are displayed the number 205 of alpha helixes and beta strands and clustering information 206 based on protein-protein homology, as feature quantities of the proteins.

With regard to interaction data that is displayed on the screen in a table format, it is also possible to perform clustering based on an interaction data profile or clustering based on the feature quantities of proteins or LMW compounds, and then display the data based on the resultant clustering information.

Clustering using interaction data is conducted by the following method, for example. A particular LMW compound Cᵢ is considered, and an interaction intensity profile Iᵢⱼ (j=1, . . . , Nₚ, Nₚ is the number of proteins) of each protein Pⱼ with respect to the LMW compound is considered. Then, the distance Dᵢₖ between interaction intensity profiles is calculated for all of the LMW compounds on a round robin basis. The distance Dᵢₖ between interaction intensity profiles of a LMW compound Cᵢ and a LMW compound Cₖ is calculated in accordance with the following equation, for example:
Dᵢₖ=\sqrt{Σ(Iᵢⱼ−Iₖⱼ)²}
where Iᵢⱼ is the interaction intensity between the LMW compound Cᵢ and the protein Pⱼ.

The sum in the above equation is taken for j=1, . . . , Nₚ.

By providing a threshold value for the round-robin Dᵢₖ obtained from the above equation, it becomes possible to cluster the LMW compounds. Then, focusing on a single protein Pᵢ, the interaction intensity profile Iᵢⱼ (j=1, . . . N_{c}, N_{c} is the number of LMW compounds) of each LMW compound Cⱼ is considered with respect to the protein Pᵢ. By calculating the distance between the interaction intensity profiles of all of the proteins on a round-robin basis, as in the case of the LMW compounds, it becomes possible to cluster the proteins.

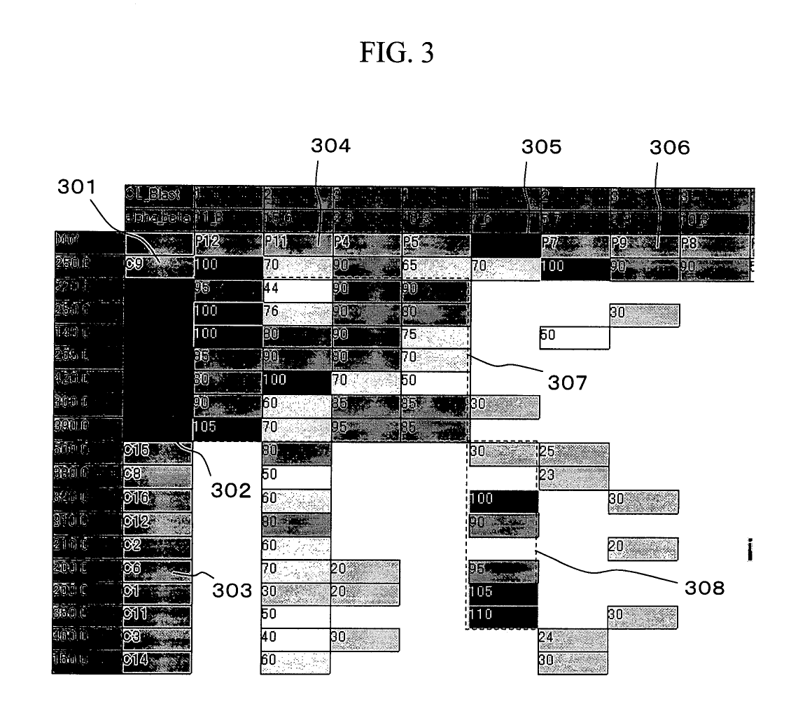

FIG. 3 shows the result of actual clustering performed.

LMW compounds are classified into three clusters, and proteins are also classified into three clusters. The results are displayed in an identifiable manner with different shades, with a LMW compound cluster A301, a LMW compound cluster B302, and a LMW compound cluster C303 shown over the labels for the LMW compounds, and with a protein cluster A304, a protein cluster B305, and a protein cluster C306 shown over the labels for the proteins. An average value of coupling constants is internally calculated for each cluster as interaction data, and the clusters are sorted from top to bottom and from left to right in accordance with the averages of coupling constants. Thus, as a general tendency, those cells with high coupling constants (with darker shades) are positioned at the upper-left of the matrix, while those cells with lower coupling constants or whose coupling is less than the threshold value are positioned at the lower-right of the matrix. Such clustering based on the interaction profile allows for the visualization of a cluster 307 consisting of pairs of particular LMW compounds and proteins, and a cluster 308 including many compounds that specifically interact with a single protein, for example. Thus, it becomes possible to adopt an approach, whereby, in an application to the research into drug discovery, a core structure common to the clusters of LMW compounds created on the basis of the interaction profile can be extracted and used as a pharmacophore carrying the functions of a drug as a seed for structural expansion.

Similarly, it is possible to cluster molecular weights into several divisions, or to classify the numbers of alpha helixes and beta strands of proteins according to certain rules. In this way, it becomes possible to individually rearrange display data for clusters based on molecular weight, clusters based on the number of alpha helixes and beta strands, or clusters based on the homology of amino acid sequences that is calculated in advance. In particular, if a characteristic color pattern of coupling constants appears as a result of rearranging the data according to a certain feature quantity, it can be known that the feature quantity and the coupling constants are closely associated.

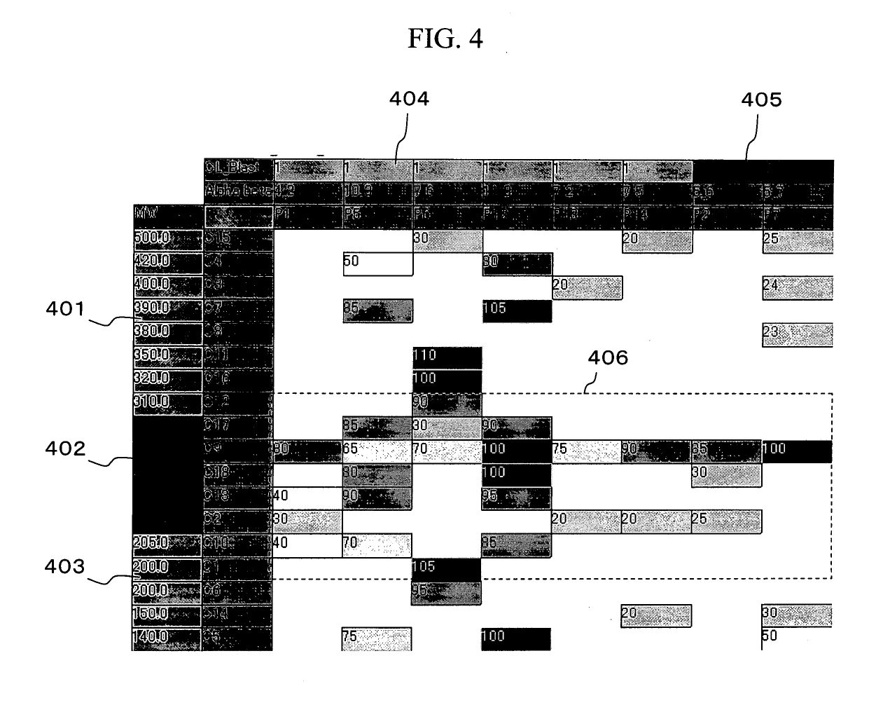

FIG. 4 shows the result of rearranging the table in accordance with the result of clustering the LMW compounds based on molecular weight and the proteins based on the amino acid homology. The LMW compounds are classified according to molecular weight into a cluster A401 with a relatively large molecular weight, a cluster B402 with an intermediate molecular weight, and a cluster C403 with a relatively small molecular weight. The data as a whole is sorted in decreasing order of molecular weight. The proteins are classified into a first cluster 404 and a second cluster 405 according to amino acid sequence homology, as displayed on the screen. In the illustrated example, the LMW compounds of cluster B appear to be overlapping a region 406 with a relatively strong interaction in the interaction matrix. On the other hand, there appears no visually recognizable correlation between the clustering result based on the amino acid homology and the interaction intensity. By thus performing clustering with regard to feature quantities and rearranging data in accordance with the result, it could become possible to discover a feature quantity that explains the interaction data well. As a well-known example of feature quantities (molecular characteristic) possessed by a LMW drug, there is the “Rule of five” (Advanced Drug Delivery Reviews, 23 (1997) 3-25) by Dr. Christopher A. Lipinski. It is believed that, by simultaneously visualizing the clustering result based on feature quantity and the interaction data, it becomes possible to establish rules regarding the feature quantities for explaining certain experimental data, or feature quantities that a LMW compound as a possible target for a particular protein should have.

In the data display in the form of a table as shown in FIG. 3 or 4, each cell in the table corresponds to an interaction between a single protein and a single LMW compound. This is herein referred to as “an individual data display format.” The individual data display format, however, has a disadvantage that, as the number of proteins or LMW compounds increases, the table becomes larger and so it becomes more difficult to grasp the data as a whole. Namely, unless the individual cell size is changed in accordance with the increase in the number of data items, the table would not fit within the screen and it would become impossible to view the data as a whole. Conversely, by reducing the individual cell size in the table so as to fit the entire table within the screen, patterns of the interaction data displayed in the cells would become so small that it becomes difficult to recognize their features. In order to allow the interaction patterns in the table as a whole to be recognized at a glance even if the number of data items increases, therefore, it is herein made possible to display the information using the individual clusters in FIG. 3 or 4 as a single cell on the table. This is herein referred to as “a cluster display format.”

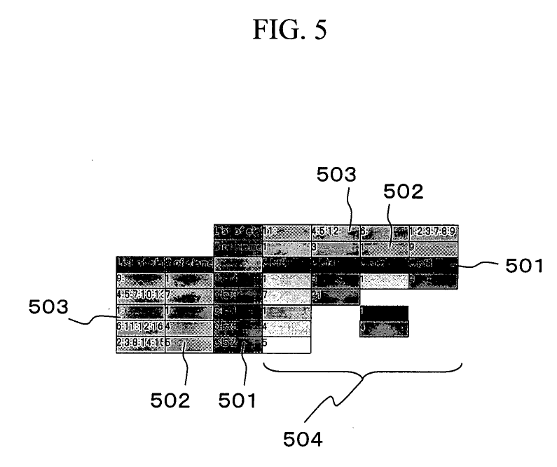

FIG. 5 shows an example of the cluster display format. In labels 501, cluster numbers are entered. As feature quantities, the number 502 of elements that belong to a cluster and a list 503 of elements that belong to a cluster are shown. In a matrix portion 504, average values of measurement data for each cluster are displayed with different shades, and the number of elements of which a cluster is comprised is indicated by a numerical value. Information display can be switched between the individual data display format and the cluster display format. Rearrangement of rows or columns or other operations such as deletion in one display format is reflected in the other display format. Because in the cluster display format, clusters are formed by similar proteins or similar LMW compounds, representative data can be visualized without fail. By controlling the number of clusters at the same time, the number of rows or columns of the displayed table can be controlled even when the number of interaction data items is large.

As a supplementary information display format to the individual data display format and the cluster display format, there is “a statistical quantity display format.” This is a format wherein statistical calculations are performed on all or part of the data and the resultant average values or standard deviations, for example, are displayed, or wherein the number of data items extracted from a different data source is displayed. In the statistical quantity display format, it is possible to have an overview of the data regardless of the number of the interaction data items. When the number of data items increase, it becomes difficult to recognize the interaction pattern of the table as a whole at a glance. In such cases, the statistical quantity display format proves very effective for grasping the overall picture of the data.

In accordance with the invention, a plurality of display formats are prepared. In addition, different levels of summarization of information to be displayed in the individual cells of a matrix are prepared, and an appropriate one can be selected depending on the number of data items.

For the display of the interaction data between proteins and LMW compounds, four levels of summarization (0 to 4) are prepared. At summarization level 0, all of the information stored in the database and the statistical quantities and the like calculated therefrom are displayed. At summarization level 1, character data of up to 64 letters per cell, signs, or colors can be displayed. It is also possible to display information consisting of 64 letters or fewer in a text field of the database, or even longer information as long as it can be reduced to 64 letters or fewer. At summarization level 2, character data consisting of up to 8 letters per cell, signs, or colors can be displayed. At summarization level 3, no character data is displayed and instead the entire information is represented by colors.

In actual implementation, the information display at summarization level 0 is performed on a free format basis. At summarization level 1, the size of each cell is defined as consisting of 60 pixels vertically and 120 pixels horizontally, in which a region is secured for displaying 16 letters×4 rows of text. At summarization level 2, the size of each cell is defined as consisting of 20 pixels vertically and 60 pixels horizontally, in which a region is ensured for displaying 8 letters×one row of text. At summarization level 3, the size of each cell is defined as consisting of 5 pixels vertically and 5 pixels horizontally. In principle, it is possible to reduce the single cell size down to 1 pixel×1 pixel. However, the cell size is selected such that individual data items can be manipulated using the mouse.

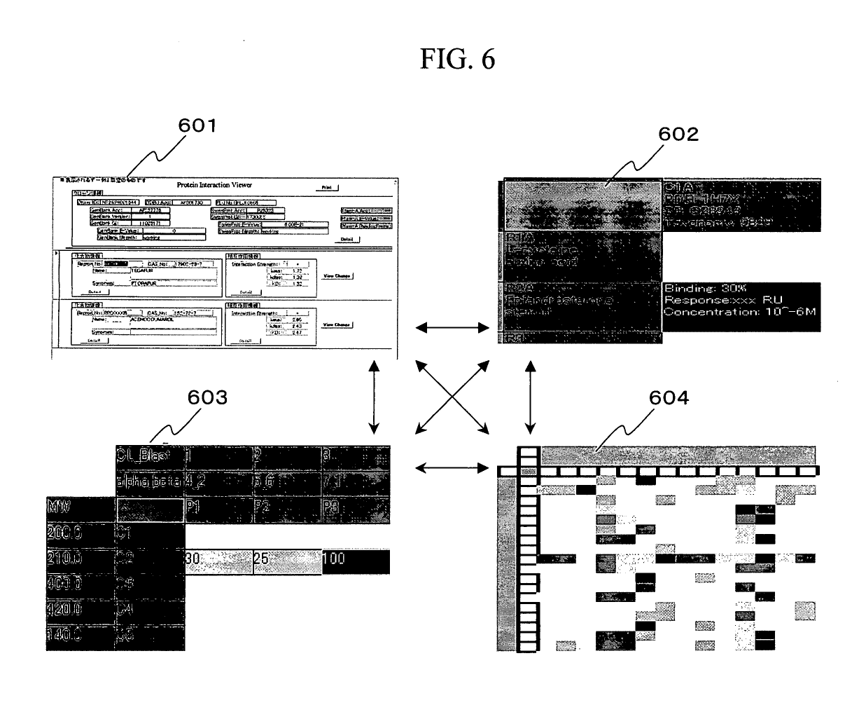

Screen display at these four summarization levels can be switched. FIG. 6 shows examples of the screen display of information at the four summarization levels in the individual data display format.

In a screen display 601 at summarization level 0, interaction data, LMW compound data, and protein data are displayed in detail. The display format is free, so that it is possible to display and manipulate the structure of a protein or LMW compound, for example.

In a screen display 602 at summarization level 1, keys for accessing various external protein-related databases, the names and therapeutic effects of LMW compounds, and detailed values of measurement data about interaction, for example, are displayed.

In a screen display 603 at summarization level 2, the displayable character data is limited to 8 letters, so that limited information, such as the labels for identifying the row or column and major values of measurement data about interaction are displayed.

In a screen display 604 at summarization level 3, the values taken by the individual cells are converted into color information when displayed. In this way, similar data can be visually recognized from the color pattern.

For the data items that are selected, it is necessary to create a rule regarding how the information is to be summarized at a given summarization level. A basic rule is such that, at summarization level 0, all of the information is displayed; at summarization levels 1 and 2, information is displayed depending on the length of the character; and at summarization level 3, information is displayed in terms of colors. In accordance with this basic rule, a detailed summarization rule must be defined for each of the data items that exist in the database.

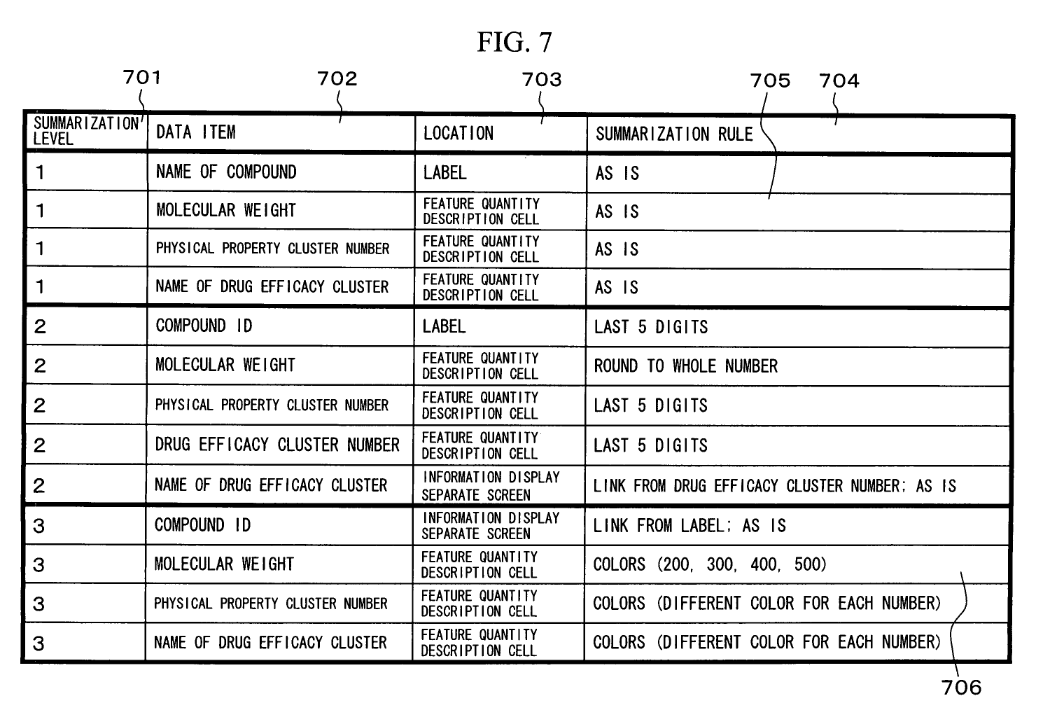

For example, FIG. 7 shows a summarization rule determination table for a LMW compound feature table. Information is given as to which data item 702 in the fields of the table is to be processed in which location 703 and according to what summarization rule 704 for screen display, depending on summarization level 701.

If the field name does not appear in the summarization rule determination table, this means that that field will not be displayed. If the summarization rule is “as is” 705, the data stored in the database will be displayed as is. In another example, if the summarization rule is “color (200, 300, 400, 500)” 706, different colors will be displayed for the five cases of the values of less than 200, 200 or more and less than 300, 300 or more and less than 400, 400 or more and less than 500, and 500 or more. Such a summarization rule determination table needs to be provided in each of the tables in the database.

So far, three data display formats and four data summarization levels have been described. By combining these, data can be visualized in a variety of different perspectives. The invention is characterized by the function whereby, as the user selects desired information, an optimum data display format and data summarization level are automatically determined in accordance with the number of data items in the selected information.

Examples of input data necessary for the automatic determination of the data display format and the data summarization level when visualizing interaction data concerning proteins and LMW compound, for example, include the number P of proteins, the number C of LMW compounds, the number Pc of protein clusters, the number Cc of LMW compound clusters, and parameters×(height) and y (width) of the information display region on the screen. When there are multiple kinds of clusters, the number of clusters registered as an initial setting is used.

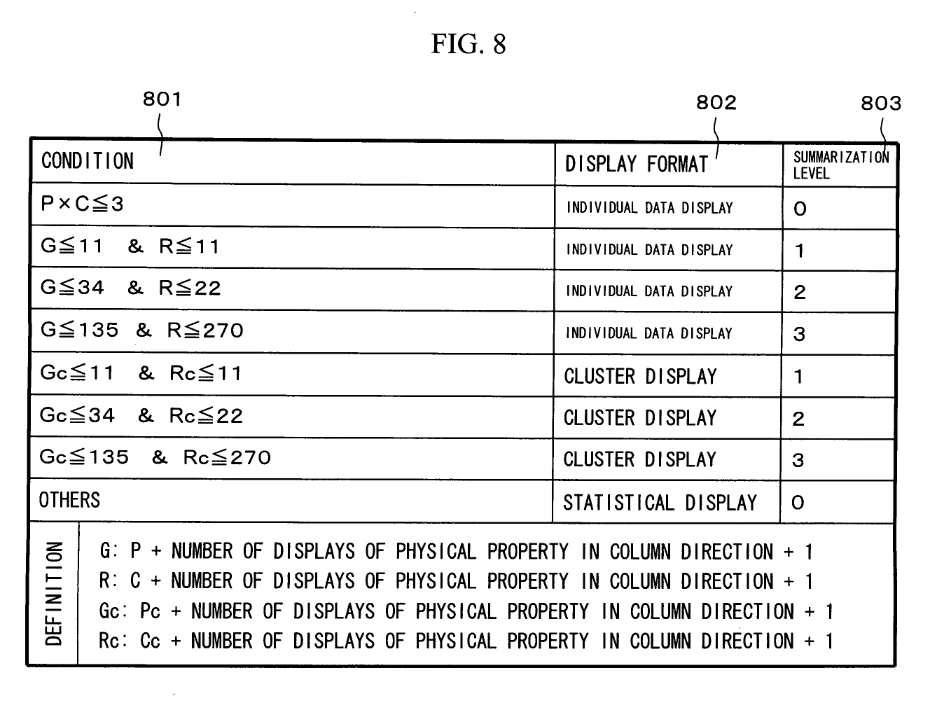

FIG. 8 shows a table of rules for determining the data display format and the data summarization level. Condition 801 is viewed one by one from the top and a display format 802 and a summarization level 803 described in the line where the condition is satisfied are adopted. If the condition is not satisfied, the condition in the next line is viewed. G, R, Gc, and Rc are the values defined in FIG. 8. The table is described below.

If P×C (corresponding to the number of cells in the display screen) is smaller than a predetermined value (3 in the example), summarization level 0 is used for the individual data display.

If P×C>3, G≦11, and R≦11, the number P of proteins and the number C of LMW compounds would be both 2 or more and 9 or less when the number of displays of feature quantities in the column direction and the number of displays of feature quantities in the row direction are both 1. In this case, the summarization level 1 is used, so that the size of a single cell would be 60 pixels vertically and 120 pixels horizontally. Thus, in the information display region of 450 pixels vertically and 900 pixels horizontally, the display size for the entire data would be 240 pixels vertically×480 pixels horizontally to 660 pixels vertically×1320 pixels horizontally, which is within 1.5×1.5 times the entire information display region.

As the number P of proteins and the number C of LMW compounds increase, the summarization level is increased from 2, 3, and so on sequentially in accordance with FIG. 8. If the numbers P and C further increase, the display format is switched to the cluster display format, and the summarization level is increased from 1, 2, 3, and so on, as the number Pc of the protein clusters and the number Cc of LMW compound clusters increase.

The conditions with regard to G, R, Gc, and Rc for the switching of display format and summarization level are set such that the display size for the entire data would be within 1.5×1.5 times the entire information display region. If a generalized standard that information regarding the entire data be displayed within n×m times the data display region is to be satisfied, the following generalized condition can be used for the determination of the data display format and summarization level:

x×n≦P (or Pc) and y×m≦C (or Cc)

In this way, it becomes possible to display the entire data, or an amount of data that is a certain multiple of the entire data, within the information display region. Also, by increasing or decreasing the summarization level depending on the decrease or increase in the number of data items, it becomes possible to display a maxim amount of information within a cell that can be recognized at a glance. Thus, it becomes possible to observe the entire picture of the data while the amount of information that can be obtained from each cell is maximized, regardless of the number of data items to be displayed.

In the process of discovery of targets for the creation of new drugs, it is extremely important to visualize the interaction between proteins and LMW compounds and, at the same time, to acquire information about other relevant biological interactions, put the information in order comprehensibly, and understand them. Examples of the relevant biological interactions include interactions between LMW compounds regarding drug efficacy or toxicity, interactions between proteins, and information regarding proteins and expression. In accordance with the invention, it is possible to acquire those related information and then display them depending on the number of data items acquired and in accordance with the above-described determination rule regarding the display format and summarization level.

Related information is acquired in the following manner. A cell region of interest in a displayed data table is selected, and then the LMW compound IDs and the protein IDs that belong in the cell region are extracted. A related data table is searched for these IDs, and the information associated with the retrieved IDs are extracted from the related data table.

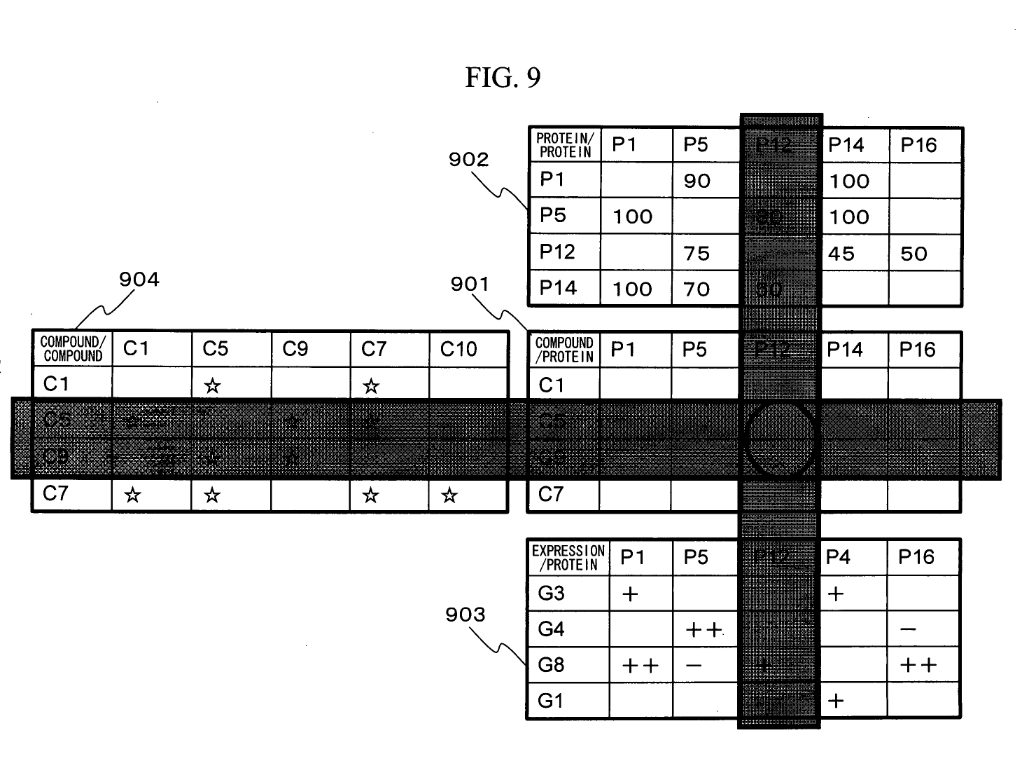

FIG. 9 shows a concrete method for extracting related information. When two items of a protein-LMW compound interaction table 901, namely, (C5, P12) and (C9, P12) are considered, those of the cells of a protein-protein interaction table 902, which standardizes the protein-protein coupling strength against a maximum value of 100, and of a protein-expression table 903, which indicates the quantitative expression amounts of protein in an expression library, are extracted that have P12 as the protein ID and for which data exists. Similarly, those of the cells of a LMW compound-LMW compound interaction table 904, in which data regarding the presence or absence of effects due to multiple drug use between LMW compounds is stored, are extracted that have C5 and C9 as IDs and for which data exists.

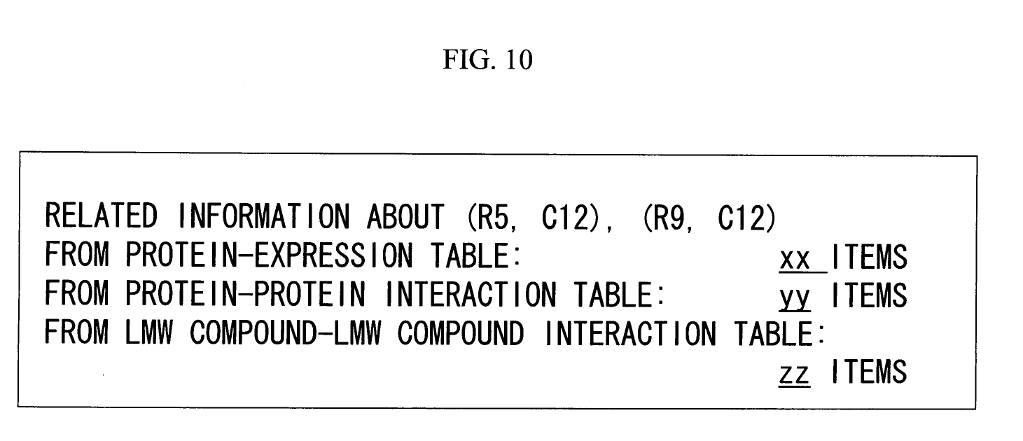

The result of extraction of related information is displayed as arranged for each table from which the information has been extracted, as shown in FIG. 10. When the user selects a table he or she wishes to see, an information display format and summarization level are automatically set depending on the number of hits, and information is displayed in the display format and at the summarization level that have been set. Related information can also be acquired from part of the information thus displayed. Thus, the invention allows the visualization of multi-dimensional interaction data by efficiently tracking the links between the one-to-one interaction data.

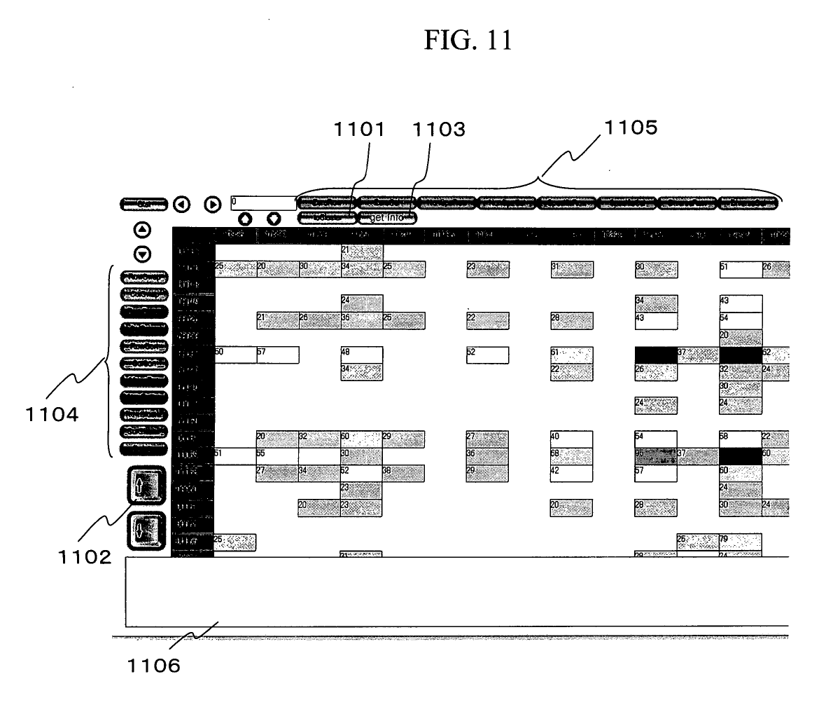

In accordance with an interface implementing the visualization method of the invention, part of the information displayed on screen is selected, an action selected from a plurality of actions is performed on the selected data, and the information obtained as a result of the action is displayed on screen. FIG. 11 shows an example of the user interface. In addition to a display mode change button 1101, a summarization level change button 1102, and a related information acquisition button 1103, there are provided a function group 1104 related to actions, such as replacement, rearrangement, clustering, and deletion of rows or columns, and a function group 1105 related to the selection of characteristic rows or columns or those rows or columns as representative subsets. A mouse-operated action is assigned to each of the cells displayed on screen in the table format, allowing a row or column to be selected, or long character string data that cannot be displayed within the cell to be displayed on a related information display screen 1106.

### Embodiment 2

With reference to this embodiment, how knowledge useful for the creation of drugs is extracted by rearranging interaction data and visualizing the result of analysis of resultant clusters is described. As an interaction between two events, the binding strength between proteins and LMW compounds is considered. The values of the binding strengths are the dissociation constants acquired from the Protein-Ligand Database (http://www.mitchell.ch.cam.ac.uk/pld/), each of which is described in literature. When only those binding strengths with dissociation constants of 10⁻⁵ or smaller are extracted, the interaction information can be described as a matrix consisting of 95 kinds of LMW compounds and 67 kinds of proteins.

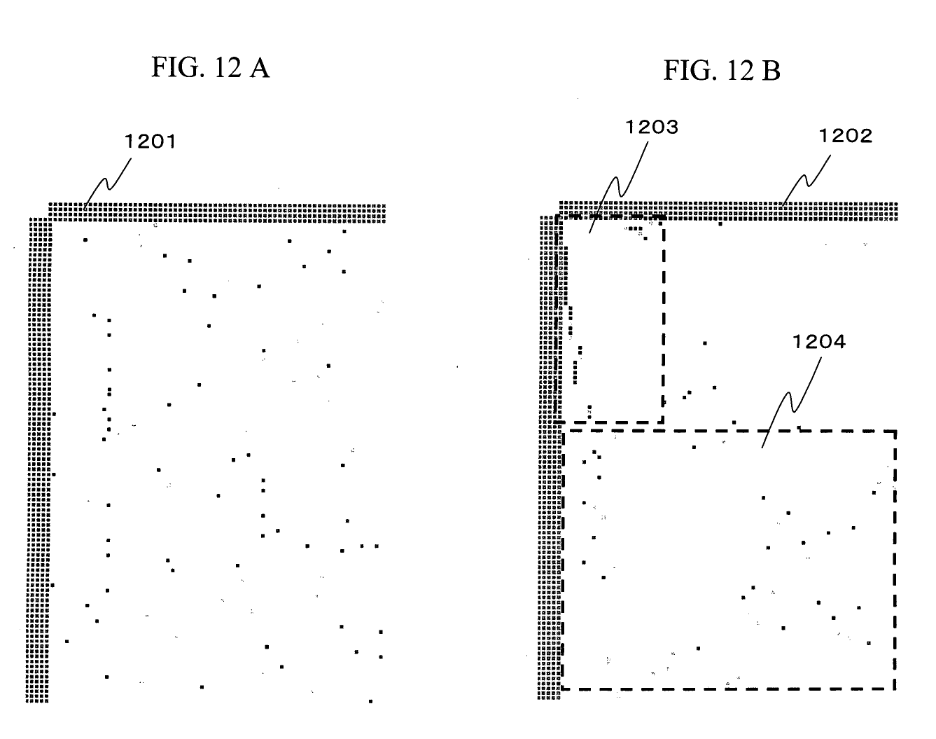

FIG. 12 shows results before and after clustering the PLD data into 25 groups of LMW compounds and 15 groups of proteins based on similarities in the matrix. A matrix 1201 before clustering is rearranged into a matrix 1202 after clustering. Prior to clustering, dots indicating pairs of interacting proteins and LMW compounds are scattered on the matrix. After clustering, rows or columns with similar interaction intensity patterns are displayed in proximity to one another. In a region 1203 where meaning can be read in the clustering result, regions with strong interaction appear distinctly as “islands” on the matrix. However, there is also a region 1204 where dissimilar interaction data commingle in the clustering result. In this region, it can be interpreted that the individual dots on the matrix, namely, individual items of interaction intensity data, do not have similarity to one another.

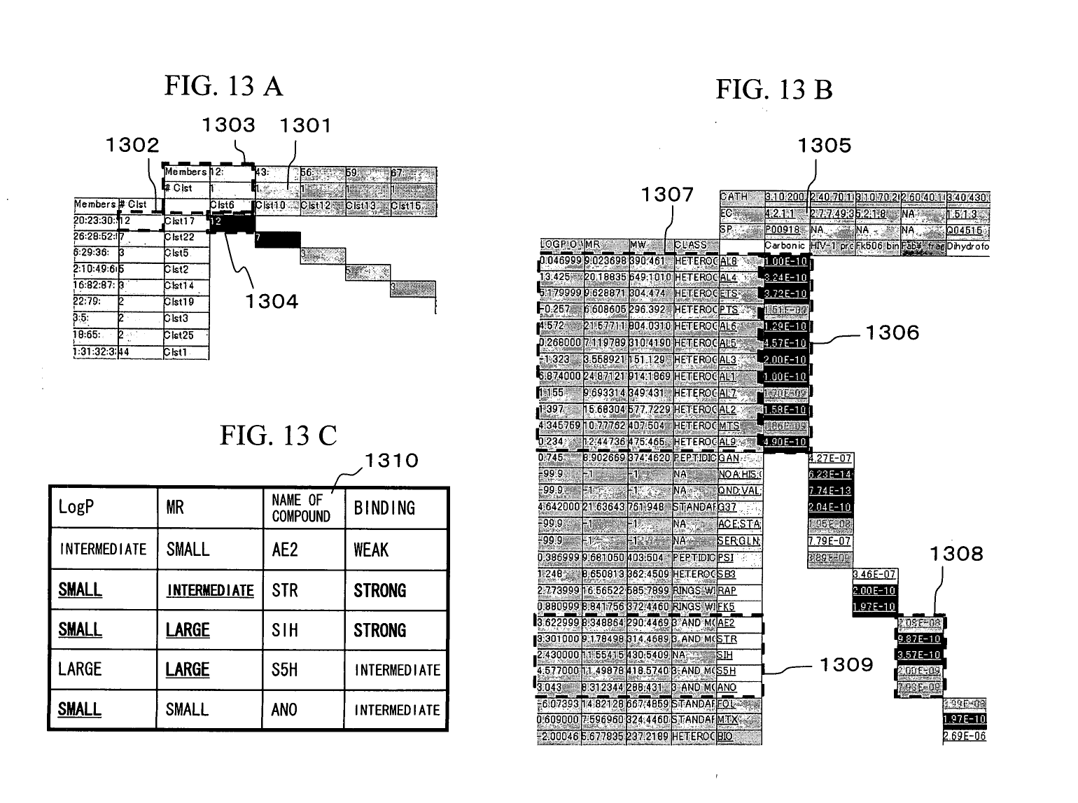

FIG. 13 shows two examples of displaying the clustering result of the PLD data. The data belonging to each cluster must have similar interaction intensities if the clustering result has meaning. Therefore, the number of rows or columns in the table can be reduced by expressing all of the elements included in a cluster with a single representative value. As such representative value, an average value is used in the present examples. In an example 1301 where some of the matrix data having clusters as units is displayed on screen at summarization level 2, there are displayed the number 1302 of LMW compounds that belong to a cluster, the number 1303 of proteins that belong to a cluster, and the number 1304 of interactions that belong to a cluster defined by the product of these numbers 1302 and 1303. Because in the present example the LMW compounds are clustered into 25 groups and the proteins into 15 groups, the size of the entire table becomes 25×15. In the analysis of an interaction matrix between proteins and LMW compounds, attention is focused on those elements among the clusters that have high interaction intensity. Thus, as indicated in 1301, rearranging the table of clustering results in a diagonal direction in order of decreasing interaction intensity is equivalent to rearranging the data in order of priority of interest. Initially, the position of the element where the maximum value is placed is identified from the matrix of 25×15. If the position of the element is (p, q), for example, it can be shifted to (1, 1) of the matrix, namely, to the upper-left corner, by replacing the line p and the column q with the first line and the first column of the matrix, respectively. By repeating this operation, the clustering result is arranged in the diagonal direction, with the sole difference being that, in the second round of operation, the element with the maximum value is searched for from the matrix from which the first row and column have been eliminated, namely, a matrix of 24×14, and then the element is shifted to the position of (2, 2). It is also possible to return the matrix displayed in units of clusters back to the display 1305 by means of the matrix having individual proteins and LMW compounds as units. In this case, because the number 1304 of interactions that belong to the aforementioned cluster has 12 elements, it would be rendered into a cluster 1306 represented by a matrix of 12 vertically×1 horizontally if displayed in units of proteins and LMW compounds.

In the following, a method for extracting attributes common to LMW compounds from a cluster obtained on the basis of interaction is described. As physical property values 1307 of the compounds that are the elements of the cluster obtained above, structural class, molecular weight, molar refractivity, and the water/octanol partition coefficient can be simultaneously observed. From the simultaneous observation of the clustering result based on interaction intensity and the physical property value, it can be learned that all of the compounds as the elements of this cluster belong to the same structure class, namely, they are hetero cyclic aromatic compounds (aromatic compounds with a heterocycle). However, it is not easy to explain the relationship between the numerical information, such as molecular weight, molar refractivity, and the water/octanol partition coefficient, and the interaction intensity. Molecular weights alone range from 200 or less to 900 or more. The fact that compounds with such diverse physical property values strongly bind to the same protein makes it possible to imagine that there is a partial structure in these compounds that is indispensable to their binding with the protein. The physical property values themselves will naturally come to have different values if the remaining structure added to the indispensable partial structure varies greatly. In accordance with the invention, the labels of compounds can be clicked to actually compare their structures. Such comparison of structures makes it possible to estimate a common structure of the compounds or their active site. Detailed analysis for that purpose is outside the scope of the invention and is therefore omitted herein. Meanwhile, there is a cluster 1308 in which the physical property values of the compounds correspond to interaction intensities. When the physical attributes 1309 of the compounds that are the elements of the cluster 1308 are observed, it can be seen that the range of possible values is relatively limited for all of the attributes, namely, molecular weight, molar refractivity, and the water/octanol partition coefficient. With regard to molar refractivity, it is between 8.3 and 11.5, and the log P value is between 2.4 and 4.5. Most of the compounds that belong to this cluster are in the class of three or more ring systems (compounds having three or more ring structures). Observation of a table 1310, in which the values of the interaction intensities of the cluster 1308 and the physical property values 1309 of the compounds are projected onto three levels of values, sheds light on more detailed relationship between the physical property values and the binding strengths. In order to achieve a strong binding, two conditions in terms of physical property values must be satisfied at the same time, namely, the water/octanol partition coefficient is small, and molar refractivity is either intermediate or large. If either one of the conditions is satisfied, the binding strength would be intermediate. If neither conditions are satisfied, the binding strength would become minimum among the compounds in the cluster. Such examples indicate the possibility of designing compounds that more specifically bind to corresponding proteins, taking into consideration the structure and physical property values of the compounds. In the present example, it is predicted that compounds whose molar refractivity is between 9 and 11.5 and whose log P value is between 2.4 and 3.3 could possibly more specifically bind to the corresponding proteins.

### Embodiment 3

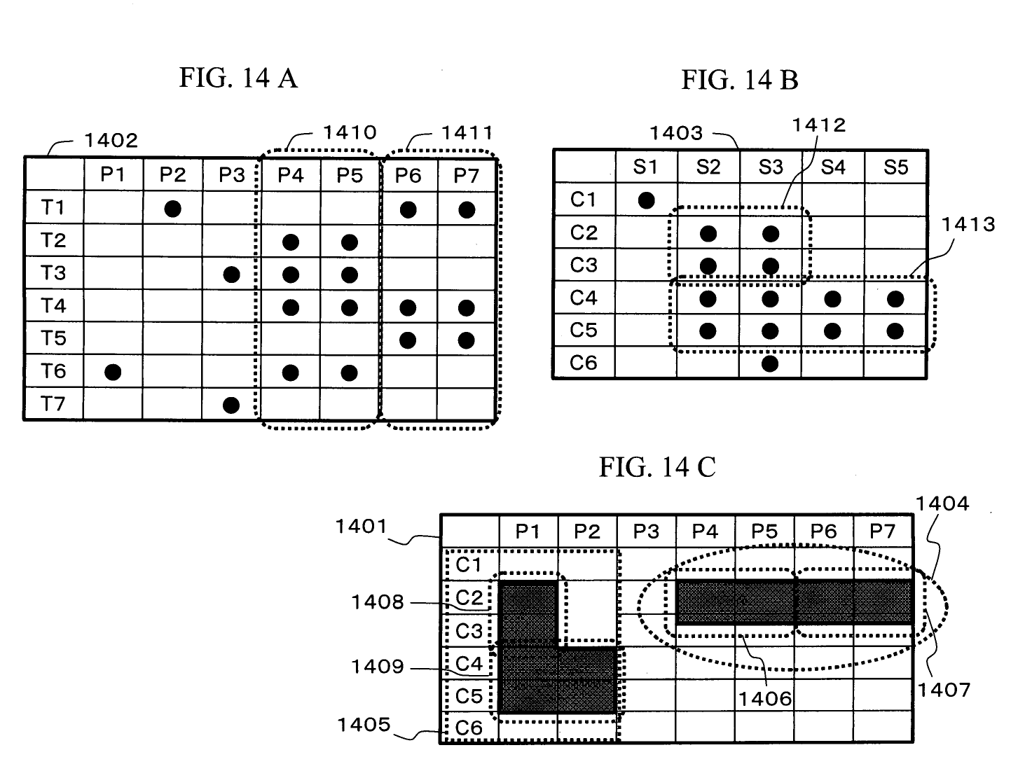

With reference to FIG. 14, a method for extracting attributes commonly possessed by compounds or proteins from a cluster obtained on the basis of interaction is described, with regard to a case where the attributes of the compounds or proteins are expressed by a profile consisting of a plurality of elements. FIG. 14 shows an expression profile matrix 1402 in a cell tissue, which is obtained as an attribute of proteins, and an adverse event matrix 1403, which is obtained as an attribute of LMW compounds, both of which are shown in proximity to a matrix 1401 of interactions between LMW compounds and proteins. The proteins are designated by P1 to P7, cell tissues by T1 to T7, LMW compounds by C1 to C6, and adverse events by S1 to S5. The protein-protein interaction matrix may be obtained experimentally or from literature. The adverse event matrix can be obtained by examining whether or not the individual terms in the Medical Dictionary for Regulatory Activities (MeDRA), which is an international medical dictionary, appear within the items in, for example, a database of Japanese drugs (http://www.japic.or.ip/publications/index3.html) relating to adverse events.

A LMW compound-protein interaction cluster 1404 can be classified into two regions 1406 and 1407. These two regions correspond to the two protein groups (P4, P5) and (P6, P7) that have different profiles 1410 and 1411 in the expression profile matrix in the cell tissue. Thus, it can be seen that all of the proteins in the cluster 1404 interact with a common LMW compound C2 but that they interact with the two different protein groups in the expression profile in the cell tissue. This suggests that when this LMW compound is a drug, it interacts with two kinds of target proteins that have different physiological functions. Further, by examining the function of the counterpart protein with which it interacts, it is considered possible to predict the relationship with the drug efficacy of the drug.

In the display of the adverse event matrix, a LMW compound-protein interaction cluster 1405 can be classified into two regions 1408 and 1409. These two regions correspond to two groups of LMW compounds (C2, C3) and (C4, C5) that have different profiles 1412 and 1413 in adverse events. It can be seen that one of these two LMW compound groups interacts with one protein P1 but that the other interacts with another protein P2 in addition to P1. Thus, it can be predicted that the two proteins are related to different adverse event profiles.

The profiles consisting of multiple elements as the attributes of the LMW compounds and proteins may include a protein-protein interaction profile, a dendrogram profile of proteins, or a structural profile of compounds (such as by the MACCS key descriptors, for example). In all of these cases, it is possible to determine how the LMW compounds or proteins that make up clusters obtained on the basis of interaction vary in what respects when they are viewed in terms of the attributes of different profiles consisting of other multiple elements.

It is possible to construct a database in which the aforementioned results of cluster analysis are stored together with the related known information extracted from documents or patents. When the functions for the search for the known related information from the results of cluster analysis, or for the cluster analysis results from the known information, are added to the present database, the user can utilize these functions and his or her biological or pharmaceutical interpretation of the interaction clusters can be facilitated.

### Embodiment 4

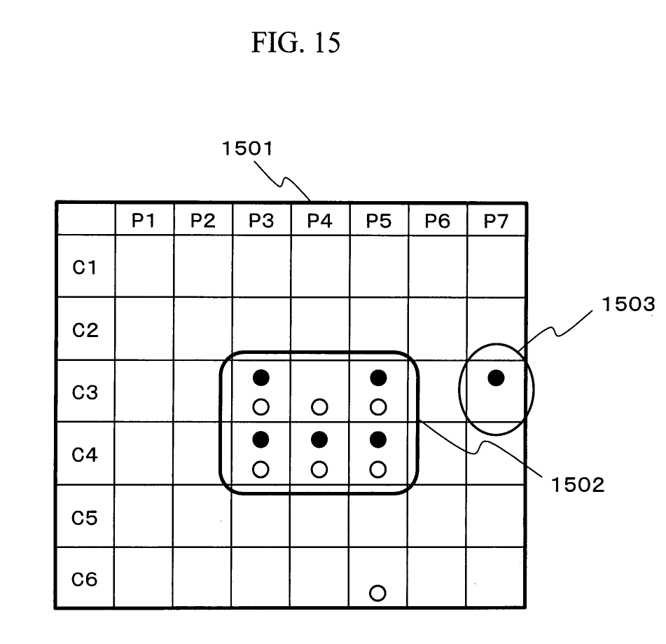

In the present embodiment, a method for displaying multiple kinds of correlation data concerning the aforementioned biological events in the cells of a matrix in an identifiable manner is described. As an interaction between two events, an interaction between proteins and LMW compounds is considered. FIG. 15 shows an example where interaction information obtained experimentally and known interaction information obtained from literature and the like are simultaneously displayed. In FIG. 15, a LMW compound-protein interaction matrix 1501 is shown. The LMW compounds are denoted by C1 to C6 and the proteins by P1 to P7. Each of the cells in the LMW compound-protein interaction matrix is divided into two, namely, upper and lower, regions each corresponding to the interaction obtained from the experiment and the interaction obtained from literature. The presence or absence of interaction is denoted by whether or not there is a sign (experiment: black circle, literature: white circle) in the divided regions. In the figure, there is shown a cluster 1502 obtained by clustering based on the known interaction information obtained from literature and the like. In the cluster 1502, by focusing attention on the interaction obtained experimentally, it is possible to evaluate how much of the known interaction information was reproduced experimentally. In the present case, it can be seen that although there is interaction between the LMW compound C3 and the protein P4 based on literature, no interaction was obtained experimentally. Also, by focusing attention on an interaction 1503 obtained experimentally that does not belong to the cluster of the known interaction information, it is possible to identify an interaction that is not available in literature but newly obtained experimentally.

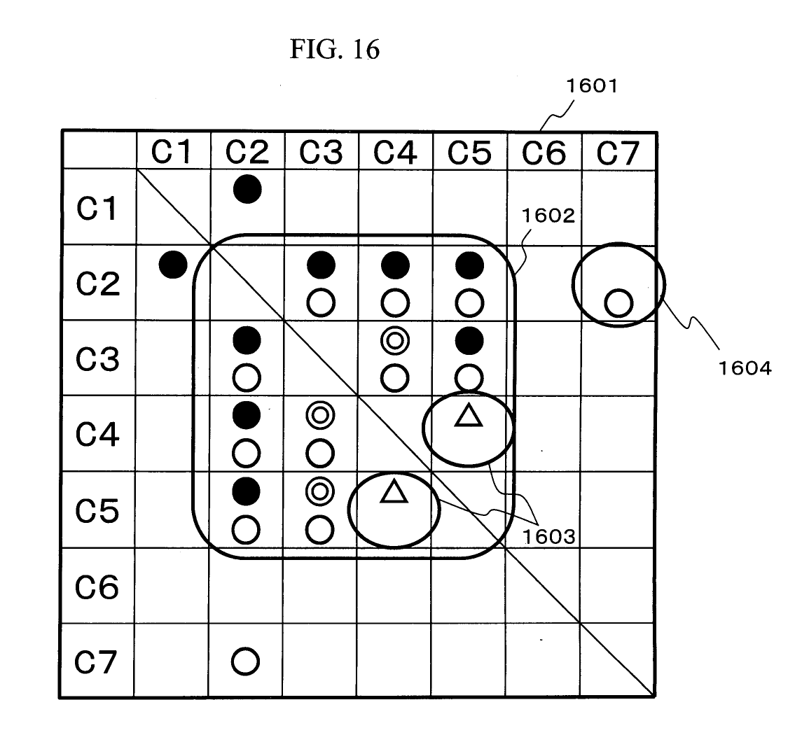

FIG. 16 shows a matrix 1601 in which chemical structural similarity information regarding pharmaceutical LMW compounds and classification information based on an adverse event matrix are simultaneously displayed. The chemical structural similarity information regarding the pharmaceutical LMW compounds can be obtained on the basis of the similarities between the MACCS key descriptors (Reoptimization of MDL keys for Use in Drug Discovery, J. L. Durant, B. A. Leland, D. R. Henry, J. G. Nourse, JCICS, 2002, 42(6), 1273-1280.), for example. The classification information based on an adverse event matrix can be obtained from a comparison between the adverse event profiles in the adverse event matrix described with reference to Embodiment 2. The cells in the matrix are divided into two regions each corresponding to the chemical structural similarity information and the classification information based on the adverse event matrix. The chemical structural similarity information and the classification information based on the adverse event matrix are denoted by the notation of signs in the divided regions. The chemical structural similarity is denoted by the density of color (black circle : high similarity; double circle: intermediate similarity; triangle: low similarity). The presence or absence of belonging to the same cluster is denoted by the presence or absence of a white circle.

FIG. 16 shows the result of clustering based on the chemical structural similarity information and then gathering the resultant clusters near the diagonal of a matrix. By comparing the chemical structural similarity among the clusters based on the chemical structural similarity information and the classification information based on the adverse event matrix, it becomes possible to clarify what extent of chemical structural similarity would be classified into the same class in the adverse event matrix. For example, there is mutual chemical structural similarity among the LMW compounds C2, C3, C4 and C5. It can be seen that, although there is weak chemical structural similarity among the LMW compounds C5 and C4 1603, they do not belong to the same cluster in the adverse event matrix. If a pair of compounds that have no chemical structural similarity, as shown in 1604, belong to the same cluster in the adverse event matrix, the presence of an adverse event that is not dependent on the chemical structural similarity can be confirmed.

Examples of the correlation data that are simultaneously displayed may include the sequence similarity and the structural similarity between proteins, the sequence similarity and the functional similarity between proteins, the sequence similarity and the expression profile similarity of proteins, the structural similarity and the drug efficacy class of LMW compounds, and the structural classifications between LMW compounds obtained by two different methods. The data may also include interaction information obtained by different experimental methods. In all of these cases, it is possible to concretely and intuitively obtain information as to in what respect a cluster obtained in accordance with one standard differs from a cluster obtained in accordance with another standard.

### Embodiment 5

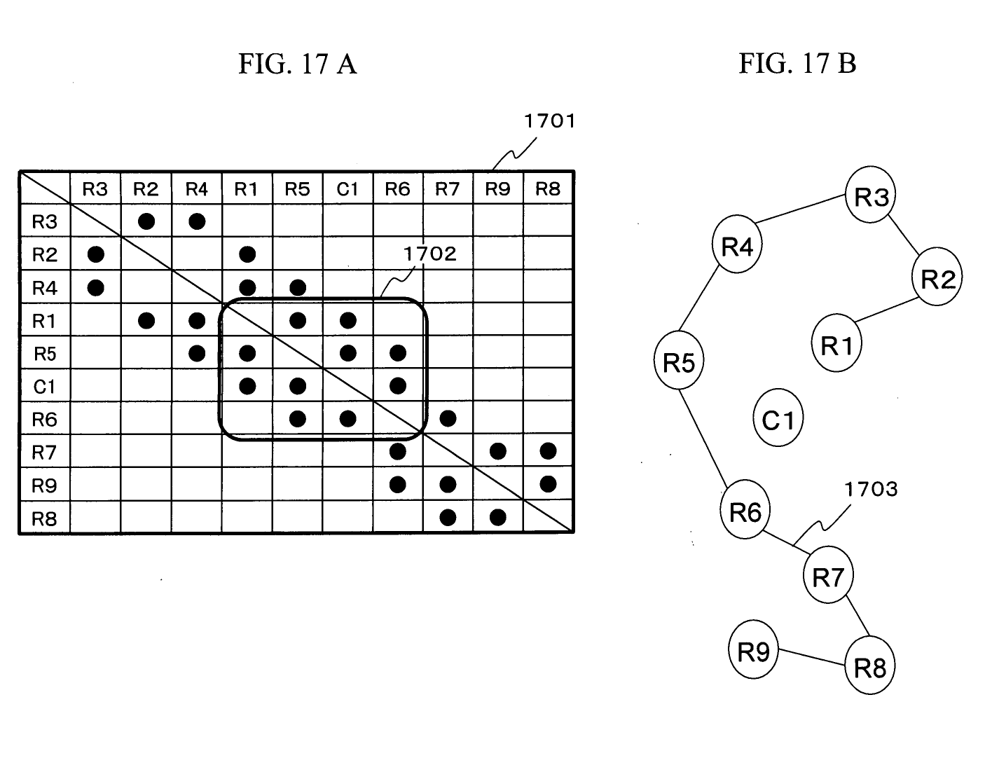

In this embodiment, a method for displaying information about complexes of proteins and LMW compounds will be described. The two biological events consist of the centers of gravity of a C_{α} atom of a protein residue and a LMW compound. A plurality of such proteins and LMW compounds may exist in a complex. The correlation data concerning them involve the distance, between C_{α} atoms the distance between the centers of gravity LMW compounds, and the distance between C_{α} atom and the centers of gravity of a LMW compound. With reference to FIG. 17, a case where there is one each of the protein and the LMW compound is described. As a method for the two-dimensional display of the protein structure, the Distance Matrix Plot has long been used, in which the distances between C_{α}, atoms of proteins are arranged in order of the residue number both vertically and horizontally. The method used in the present embodiment is similar to the Distance Matrix Plot. However, in accordance with the invention, not only the plots are arranged in order of the residue number as in the Distance Matrix Plot, but it is also possible to perform clustering of the centers of gravities of the C_{α} atom and the LMW compound based on the distance between C_{α} atoms, the distance between the centers of gravity of LMW compounds, and the distance between Cα atom and the center of gravity of a LMW compound, whereby the data can be rearranged such that members of the clusters can be gathered. FIG. 17 shows the result of indicating with a black circle the cells in the event that, as distance information, the distance is below a predetermined distance, and the rearranging the data after clustering. On the upper left of the diagonal of the distance matrix, there is a cluster 1702 that contains LMW compounds. From the observation of this cluster, it can be learned that the LMW compounds are in proximity to the amino acids of the residue numbers 1, 5, and 6 of the protein. As shown in a model 1703 of the protein-LMW compound complex, it is very often that the LMW compounds are located in proximity to the protein residues with distant residue numbers. a In the conventional Distance Matrix Plot, it is easy to observe clusters located along a polypeptide chain. However, it is not easy to identify the clusters that do not lie along the polypeptide chain but that are spatially close. In the method of the present embodiment, the clusters that do not lie along the polypeptide chain but that are spatially close can be very easily identified.

Further, when a part of the protein-LMW compound complex is desired to be enlarged, the data display format can be changed such that, instead of using the C_{α} atom of each protein residue and the centers of gravity of LMW compound for the calculation of the interatomic distance, the distance between all of the atoms of which each protein and the LMW compound are composed can be used. Of course, the hydrogen atoms may be omitted from the calculation of the distance between all of the atoms. In the display of all of the atoms, it can be easily visualized which atom of the LMW compound and which atom in which residue of the protein are hydrogen-bonded.

Furthermore, in accordance with this method, when a docking result between a particular protein and a plurality of LMW compounds with partial differences is displayed, it is possible to compare the multiple docking structures in a single matrix so as to learn which atom in the LMW compound is in proximity to which atom in the protein. In the conventional method of comparing three-dimensional structural diagrams, it has been necessary for a skilled researcher to observe the diagrams over a long period of time. However, in accordance with the present embodiment, the comparison between many docking structures can be made easily at a glance and in a quantitative manner.

### INDUSTRIAL APPLICABILITY

In a method for visualizing the correlation data concerning two biological events in a matrix format, it becomes possible, using the visualizing method of the invention and an interface implementing the visualizing method, to simultaneously observe information about correlation data patterns and the cells of which the patterns are composed in an appropriate display format and at a summarization level that are automatically selected in accordance with the variation in the amount of data, without having to manually implement operations such as causing the correlation data pattern to be coarsely visualized or accessing other sources for information about each cell depending on the size of the correlation data. As a result, regardless of the number of data items to be displayed, it becomes possible to observe the overall picture of the data while the amount of information obtainable from the individual cells is automatically maximized. Thus, it becomes possible to perform the operation of repeating the observation of the correlation data as a whole and the detailed observation of a smaller number of data items far more efficiently than by the conventional manual process. As a result, the process of discovering effective knowledge from a great amount of correlation data can be performed efficiently.

When the invention is applied to interaction data concerning biological events, such as protein-LMW compound interaction data, the user can view all of the interaction intensities at a glance. When there are a large number of data items of proteins or LMW compounds whose interaction intensities are similar, the volume of data can be compressed compactly and presented on screen. Conversely, when the user focuses his or her attention on part of the interaction data, he or she can make a decision regarding drug discovery research by referring to detailed information. The invention can also be applied to protein-protein interaction or other important interaction data for visualization and analysis purposes, whereby data processing in the process of drug discovery can be accelerated and further the drug discovery process can be speeded up.

1. A method for visualizing correlation data concerning two biological events or the correlation data and feature data regarding each event in a matrix format, the method comprising displaying correlation data concerning biological events of the same or different kinds, or the correlation data and feature data regarding each biological event in (a) one of a plurality of prepared data display formats and at (b) one of a plurality of prepared summarization levels, both of which are selected either manually or automatically depending on the number of data items in desired display data.

2. The visualizing method according to claim 1, wherein the plurality of data display formats (a) from which one is selected include: (A) a table data display format having correlation data concerning a pair of events as a single display data unit; (B) a table data display format having correlation data concerning clusters obtained as a result of clustering of events as a single display data unit; and (C) a data display format having the result of statistically processing a set of correlation data as a single display data unit.

3. The method for visualizing correlation data concerning biological events according to claim 2, wherein the clustering method (B) comprises clustering based on attribute information regarding the two biological events or correlation information between the two biological events.

4. The visualizing method according to claim 2, wherein, in the table data display format (B) having correlation data concerning clusters as a single table data unit, the results are rearranged on a diagonal in order of decreasing correlation intensity from the upper left of the table.

5. The visualizing method according to claim 1, comprising a summarization method selected from the plurality of summarization levels (b) that include display or non-display of a data field, reduction of data in a data field of the character type, and reduction of data in a data field of the numeric value type.

6. The visualizing method according to claim 3, wherein the reduction of data in the data field of the character type comprises operations of extracting a part of layers of character information in a layered structure, extracting a keyword from the character data that is registered in advance, and associating the character data with a single sign, letter, or color.

7. The visualizing method according to claim 3, wherein the reduction of data in the data field of the numerical value type comprises operations of rounding a value to an arbitrary significant digit, extracting only the exponential portion of the value, and associating values in a certain range with a color.

8. The visualizing method according to claim 1, wherein the method for automatically selecting the screen display format and the summarization level of data comprises selecting a pair of a data display format and a data summarization level depending on the number of entries of the correlation data to be displayed on screen and the size of an information display region and an information display unit that are designated in advance, such that a maximum amount of information can be provided.

9. The visualizing method according to claim 1, wherein a plurality of kinds of correlation data concerning the biological events are displayed simultaneously in the cells of the matrix in an identifiable manner.

10. The visualizing method according to claim 1, wherein the correlation data concerning the biological events comprises an interaction between LMW compounds and proteins.

11. The method for visualizing correlation data concerning biological events according to claim 1, wherein, as the biological events, a structural unit is defined on the basis of atoms in a molecule or a set of atoms in a molecule for each molecule in a complex of one or more molecules, a representative position of the structural unit is defined on the basis of the coordinates of atoms of which the structural unit is composed, and information about the distance between the representative positions of the structural units is displayed in the cells in the matrix, said matrix having each of the structural units as elements in the rows and columns thereof.

12. A method for analyzing correlation information concerning two biological events, comprising extracting a feature quantity of the biological events that is common to the members of the clusters according to claim 2.

13. A method for analyzing correlation information concerning two biological events according to claim 12, wherein the feature quantity of the biological events is represented by one or a plurality of elements consisting of values or text, or a feature quantity that expresses the three-dimensional structure of a molecule.

14. A database in which the result of cluster analysis obtained by the analysis method according to claim 12 is stored together with related known information extracted from non-patent documents or patent documents, the database further having a function for searching for the known related information based on the result of cluster analysis or for the result of cluster analysis based on the known information.

15. A computer-readable recording medium in which a program for causing a computer to implement the visualizing method, analysis method, or database according to claims 1, 12 or 14 is stored.
